(19) United States
(12) Patent Application Publication
(10) Pub. No.: US 2006/0151961 A1
(43) Pub. Date: Jul. 13, 2006

(54) Seals for coke oven doors and the use thereof

(76) Inventors: Hans-Josef Giertz, Ratingen (DE); Detlef Mattern, Essen (DE); Ralf Hoven, Essen (DE); Jurgen George, Bochum (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/544,086

(22) PCT Filed: Jan. 21, 2004
(86) PCT No.: PCT/EP04/00440

§ 371 Date: Jul. 28, 2005

(30) Foreign Application Priority Data
Jan. 31, 2003 (DE) 10303808.6
Jul. 12, 2003 (DE) 10331658.2

(51) Int. Cl. F16L 21/02

(52) U.S. Cl. 277/602

(57) ABSTRACT

The invention relates to a seal for coke oven doors comprising an encircling door frame, which is closed at the top on the oven chamber and which has even sealing surfaces on the exterior thereof. The inventive seal also comprises a door body, which can be fixed to the door frame, and comprises an encircling sealing element, which is attached to the door body and which rests against the door frame when the door is closed. A comb-shaped sealing strip (1) having a sealing edge (2) and notches (3) is attached to the door body.

The invention relates to seals for coke-oven doors according to the introductory clause of claim 1 and its use.

There are particular requirements regarding sealing around a coke-oven door, in that a good seal is required that must have a long service life. These requirements are only satisfied by some of the many known door systems. A particular problem is the extremely dirty conditions under which the door must operate, in particular the fouling of the seal strips by tarry substances that precipitate out of the coke-oven gas on the seal strip elements and the adjacent seal surfaces of the door frame. These viscous substances require periodic thorough cleaning that costs a great deal and that can damage the seal strips so that with time the seal strips of the known doors no longer seal properly. In addition there is the problem that the seal strips must compensate for deformation of the door. Since this door deformation changes with time, the seal strips must be adjustable to compensate.

German 3016165 describes a coke-oven door where a metallic seal strip is hammered for a coarse fit and then urged into position for a fine fit by means of automatic adjusters. With such a (hammer-fit) seal strip there is the problem that the seal strip has considerable inertia in the direction of the desired bending, that is the seal strip cannot fit easily to irregularities in the seal surface so that there are blow-out locations that create leaks. In addition during the coarse hammer fitting there is some recoil. Furthermore if bumps form on the seal surface the seal strip can rock. The hammer-fit seal strip is provided with J-bolts. These J-bolts cannot be optimally set. On the one hand the J-bolts have to be drawn tight to hold the hammer-fit seal strip solidly in position. On the other hand the friction should not be so great that advance of the hammer-fit seal strip is impeded.

The same is true for the setting of the spring forces of the spring biasers. The spring force must be set such that the fixation of the J-bolts is overcome and the resistance of the hammer-fit seal strip to bending is overcome. This means that in some cases a very large force is necessary that requires relatively high door-latching forces. As a result of the high door-latching forces the door latch elements and door frame are subjected to considerable loads. If such a seal is installed (retrofitted) to a door, the door latches must normally be replaced with units capable of resisting the necessary force.

The hammer-fit seal strip and even other seal strips are normally welded together at the corners. Patches of the seal strips are similarly welded in place. Such welding causes grain and size changes that require a subsequent expensive treatment of the seal strips.

It is an object of the invention, to provide a seal for a coke-oven door that can fit to all the irregularities of the door frame with modest latching forces so that the existing door latches can even be used with such a retrofit. In addition the seal should not require weld joints.

This object is achieved by the features of claims 1 and 13.

Further embodiments are seen in the features of the dependent claims.

The comb-shaped seal strip with a seal edge and slots according to the invention has very low bending resistance. This reduction is dependent on the width and depth of the slots as well as the number of slots. With the appropriate slot depth, slot width, and slot number and material thickness the seal edge of the comb-shaped seal strip is easily deformed and can be fitted very accurately to any irregularities on the seal face of the door frame. As a result of this ability to fit of the comb-shaped seal strip the seal action is significantly improved.

The slots can be made in all known geometric shapes. It is also possible to close slots at their ends away from the seal edge with webs. Even with this embodiment the bending resistance is greatly reduced. The width of the slots can also be reduced toward their ends remote from the seal edge, so that when the cam-shaped seal strip bends the smaller slot with reduces the bending resistance when the opposite edges of the slots close.

The comb-shaped seal can be secured at spaced locations with screws, retaining disks or springs or with a retaining bar. The retaining bar distributes the retaining forces along the length of the bar.

Hammering on the comb teeth of the comb-shaped seal strip drives the seal edge so toward the seal face of the door frame that the seal face sits sealingly on the door frame. The frictional forces created by the retaining disks or bar ensure that the seal edge does not spring back because of its relatively small bending resistance.

The comb-shaped seal strip according to the invention can be used in new coke-oven doors as well as in existing coke-oven doors. In a coke-oven door with a hammer-fit seal strip only the existing hammer-fit seal strip is exchanged for the comb-shaped seal strip. When retrofitting or repairing, the existing hammer-fit door seal strip does not actually have to be switched. It is possible to also mount the comb-shaped seal strip next to the hammer-fit strip. In this case the comb-shaped seal strip is either provided with its own mount or the existing mounts for the hammer-fit strip can be used.

The comb-shaped seal strip according to the invention is good for repairing seal elements. In case of a repair, when for example the seal edge of an existing seal strip or the seal face of the door frame is damaged or worn, the mounting of the comb-shaped seal strip on the damaged location can restore full sealing function. In this manner the seal strip is fitted exactly to the worn spot. It is also possible to mount the comb-shaped seal strip at the damaged location right next to the existing seal element.

The sealing between the comb-shaped seal strip making the patch and the existing seal strip is effected by complementarily fitting them together and not as hitherto by welding. Such sealing has the advantage that expensive finishing treatment of the seal edge, as necessitated by a weld joint, can be eliminated.

This sealing by complementary interfitting can be used with all the known seal elements for coke-oven doors known in the art. It is possible to make the joint a mitered or but or stepped one ore even for it to run at an angle. By use of a sealing agent, blowout of the coke-oven gas is eliminated at the start. Afterward tar naturally seals.

This sealing by complementary interfitting can be provided in the region of corner joints. A butt joint can be provided with an additional flexible end seal. A particularly good and long-lasting seal is obtained with a miter cut at a corner joint is provided with a flexible end seal. This end seal can also be coated with an elastic sealing agent.

According to a further embodiment of the invention the flexible seal can be comprised of seal plates that are provided at their ends that project from the butt joint with round heads. In this manner there is a spring action that holds the seal plates in the gap by spring action. This seal plates can form a cavity filled with a material such as Teflon, glass wool, or the like. The seal plates can also be coated on their outside faces with an elastic sealant.

Sealing of the butting seal-strip ends can be made possible with a T-part. For sealing of gas channels as known from WO 01/30039 a double-T-seal is provided.

The double-T-seal can be made particularly advantageously from the flexible end seals with seal plates and round heads. That is, the seal plates are flattened out until they lie like a double-T-seal on the outer faces of the gas channel.

The sealing can also be done with any other appropriate plug-type connection. Plug-type connections are particularly suitable when they are used with gas channels as in WO 01/30939.

The above-named as well as the other parts that are claimed and described in the examples have with respect to their size, shape, material, and technical conception no particularly exceptional restrictions, so that they can be used in many various applications.

Further particularities, features, and advantages of the invention are seen from the following description and the attached drawing in which by way of example preferred embodiments of the seal for a coke over door according to the invention are shown.

Therein:

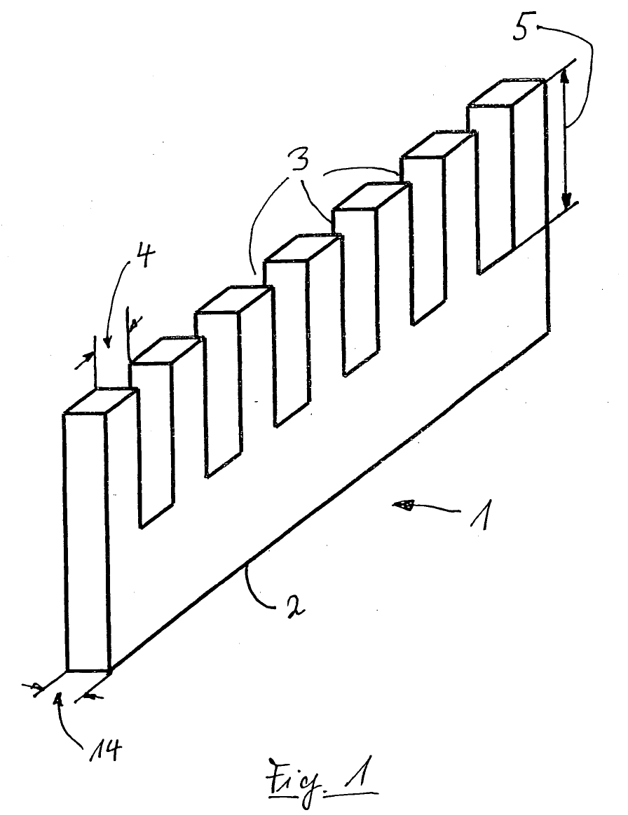

FIG. 1 is a schematic view of the comb-shaped seal strip;

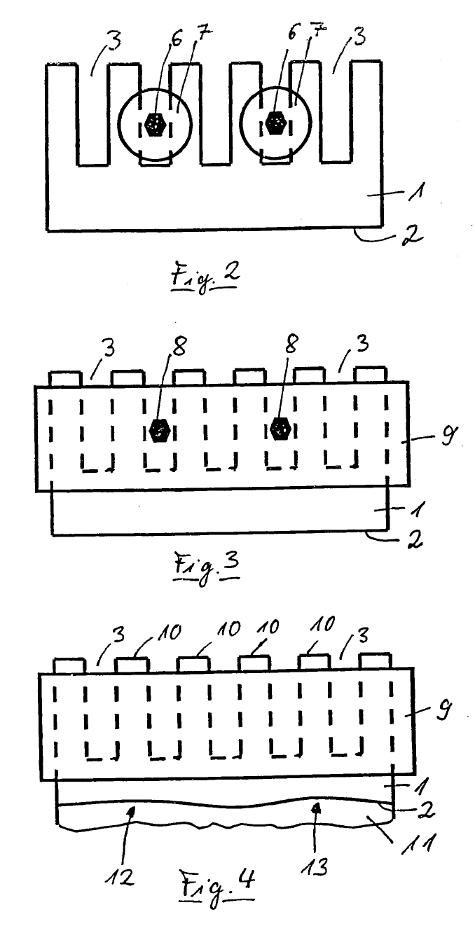

FIG. 2 shows the comb-shaped seal strip with screws and retaining washers;

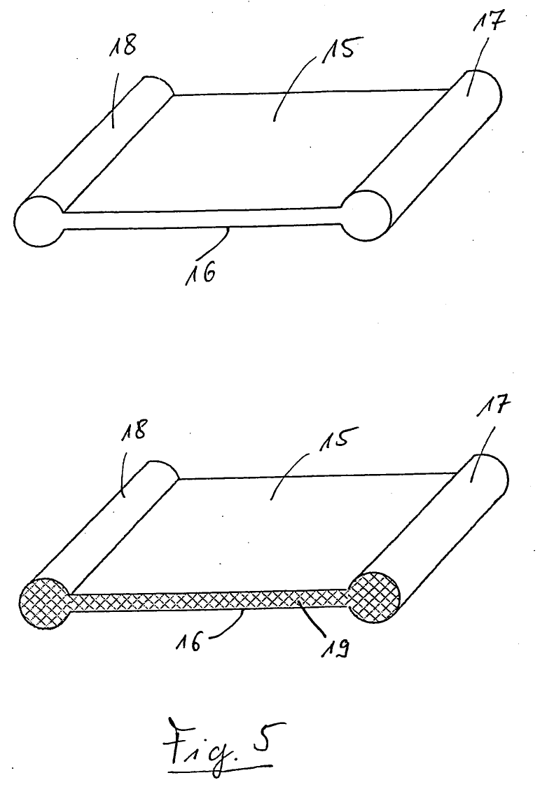

FIG. 3 is a comb-shaped seal strip with screws and a retaining bar;

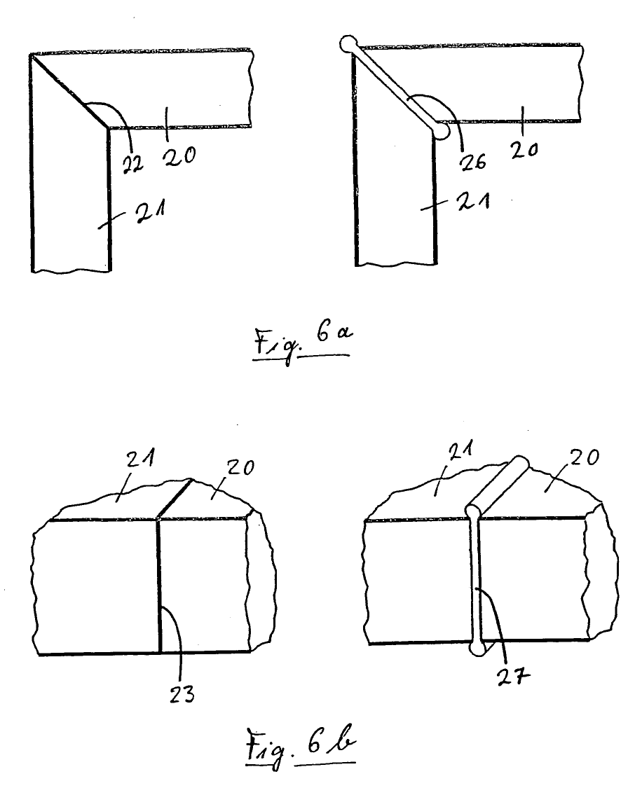

FIG. 4 shows the comb-shaped seal strip fitted to irregularities of the door frame;

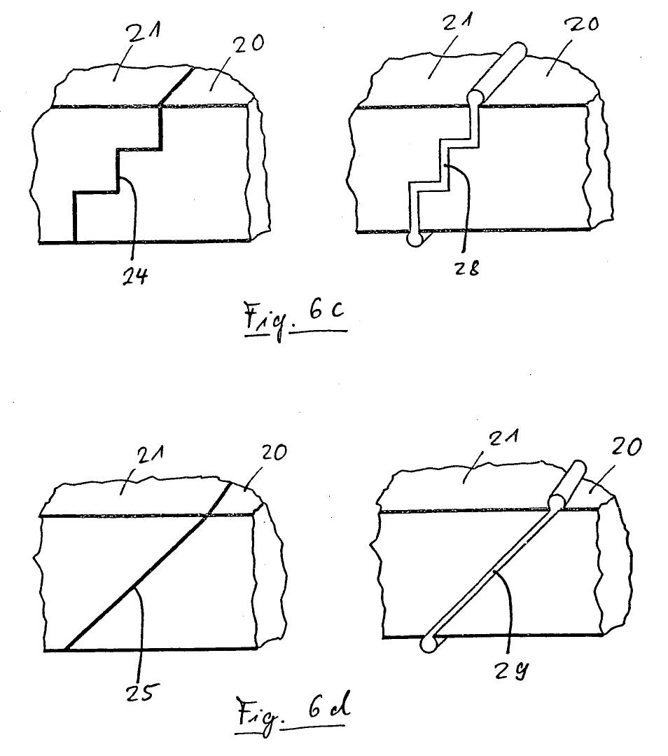

FIG. 5 is a schematic view of a flexible seal strip with spring action;

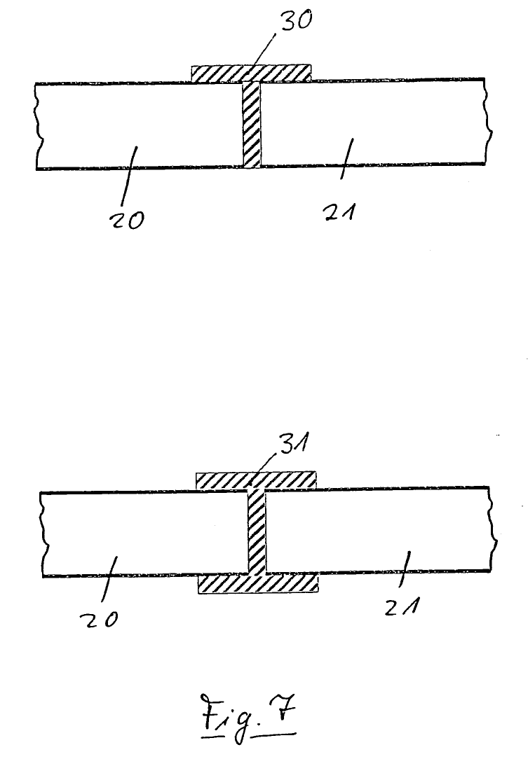

FIGS. 6a-6d are various seal strips made without weld joints;

FIG. 7 is a seal strip for a door with a T-part and a double T-part.

FIG. 1 shows a comb-shaped seal strip 1 that has a seal edge 2. Slots 3 reduces the bending resistance of the comb-shaped seal strip in the direction of the desired bending. The bending resistance can be locally influenced with a given material thickness 14 by varying slot length 4 and slot depth 5.

FIG. 2 shows that the comb-shaped seal strip 1 is mounted at spaced locations by screws 6 and retaining washers 7 on the unillustrated door.

According to FIG. 3 the comb-shaped seal strip 1 is mounted on the unillustrated door by screws 8 and a retaining bar 9. The localized retaining pressure from the screws 8 is distributed along the length of the seal strip by the retaining bar 9.

FIG. 4 shows the comb-shaped seal strip 1 with the retaining bar 9 that conforms it optimally to irregularities 12 and 13 of a door frame 11. Pounding with a hammer on comb teeth 10 drives the edge 2 of the comb-shaped seal strip 1 in spite of the friction of the retaining bar toward the seal face such that the seal edge 2 of the comb-shaped seal strip 1 conforms to the door frame 11.

FIG. 5 shows a flexible end seal formed of two seal plates 15 and 16 that are joined at their ends by round heads 17 and 18. The flexible end seal is set in the space between the ends of two seal strips such that the round heads 17 and 18 flank the seal strips. The round heads 17 and 18 produce a spring tension in the gap. The seal plates 15 and 16 press elastically against the ends of the seal strips. The region between the seal plates 15 and is 16 and the round heads 17 and 18 can be provided with a filling 19. This filling 19 can either be a seal material or an elastic material that increases the spring action. In order to further increase the sealing action of the flexible end seal, the outside of the plates 15 and 16 can also be provided with an also elastic sealant.

FIGS. 6a, 6b, 6c, and 6d show various forms of the end seals with or without flexible end seal elements. The seal strips 20 and 21 meet at a miter joint 22, a butt joint 23, a stepped butt joint 24, as well as at an angled joint 25. In order to improve the seal action, flexible end seals 26, 27, 28, and 29 can be provided in the joints.

FIG. 7 shows that two seal strips 20 and 21 can be joined t a T-shaped end seal 30 or with a double-T-shaped end seal 31.

### PARTS LIST

seal strip 1
edge 2
slots 3
slot length 4
slot depth 5
screws 6
retaining washers 7
screws 8
retaining bar 9
comb teeth 10
door frame 11
irregularities 12
irregularities 13
material thickness 14
seal plate 15
seal plate 16
round head 17
round head 18
filling 19
seal strip 20
seal strip 21
miter joint 22
butt joint 23
stepped butt joint 24
angled joint 25
flexible end seal 26
flexible end seal 27
flexible end seal 28
flexible end seal 29
T-shaped end seal 30
double-T-shaped end seal 31

1. A seal for a coke-oven door with a chamber having an upwardly closed continuous annular door frame that has an outer planar seal face, with a door body securable to the door frame, and with an annular seal element fixed on the door body and engaging the door frame when the door is closed, characterized in that a comb-shaped seal strip (1) with a seal edge (2) and slots (3) is fixed on the door body.

2. The seal according to claim 1, characterized in that the comb-shaped seal strip (1) is secured by screws (6) and retaining washers (7) on the door body.

3. The seal according to claim 1, characterized in that the comb-shaped seal strip (1) is secured by screws (8) and a retaining bar (9) on the door body.

4. A seal for a coke-oven door with a chamber having an upwardly closed continuous annular door frame that has an outer planar seal face, with a door body securable to the door frame, and with an annular seal element fixed on the door body and engaging the door frame when the door is closed, characterized in that the seal elements fit sealingly together.

5. The seal according to claim 4, characterized in that in addition to fitting sealingly together an end seal is provided.

6. The seal according to claim 4, characterized in that a flexible end seal is provided where the seal strips fit together.

7. The seal according to claim 6, characterized in that the flexible end seal is formed of two plates (15) and (16) that are connected together at their ends at round heads (17) and (18).

8. The seal according to claim 7, characterized in that a space between the seal plates (15) and (16) and the round heads (17) and (18) are provided with a filling (19).

9. The seal according to claim 8, characterized in that the filling (19) is an elastic material.

10. The seal according to claim 6, characterized in that the flexible end seal is coated with a sealing agent.

11. The seal according to claim 4, characterized in that the seal strips are fitted together at a T-part.

12. The seal according to claim 4, characterized in that the seal strips are fitted together at a double-T-part.

13. The use of the comb-shaped seal strip (1) according to claim 1 for retrofitting on and repair of an existing coke-oven door.
